(19) United States
(12) Patent Application Publication
(10) Pub. No.: US 2013/0206550 A1
(43) Pub. Date: Aug. 15, 2013

(54) CERAMIC TILE AND RUBBER PULLEY LAGGING

(71) Applicants: Aaron T. Gibbs, Easton, PA (US); Bruce S. Antonioli, Pen Argyl, PA (US); Jeffrey Alan Jurasits, Allentown, PA (US)

(72) Inventors: Aaron T. Gibbs, Easton, PA (US); Bruce S. Antonioli, Pen Argyl, PA (US); Jeffrey Alan Jurasits, Allentown, PA (US)

(21) Appl. No.: 13/372,828

(22) Filed: Feb. 14, 2012

(51) Int. Cl. B65G 23/04

(52) U.S. Cl. 198/835

(57) ABSTRACT

Pulley lagging may comprise: a resilient base and a plurality of ceramic tiles embedded therein. Each ceramic tile includes a tile body having a thickness that is less than the thickness of the resilient base and having a plurality of side surfaces extending between first and second broad surfaces thereof and tapering inwardly towards the second broad surface; wherein the first broad surface is larger than the second broad surface. The ceramic tile preferably has intersecting grooves on the first broad surface and a plurality of raised nubs on the second broad surface. Substantially all of the tile body is preferably embedded in the resilient base, whereby the raised nubs extend from the resilient base.

The present invention relates to a pulley lagging and, in particular, to ceramic tile and rubber pulley lagging.

In conveyor systems, a conveyor belt forms an endless belt that loops around at least two major pulleys, one at each end of the loop. One of the pulleys is driven to rotate so as to cause the conveyor belt to move and the other of the pulleys is not powered, but is an idler pulley that merely rotates on an axis as the conveyor belt moves past it. The drive pulley is typically driven by an electric motor or by a diesel or gas or other internal combustion engine, and the idler pulley is rotated by the force of the movement of the conveyor belt. Other pulleys and/or rollers, e.g., support rollers and/or idler rollers, provide support for the upper portion of the belt, called the “carry side,” and for the lower portion of the belt, called the “return side.”

Because the force needed to move the conveyor belt and whatever load it may be carrying can be quite high, there must be sufficient friction between the drive pulley and the conveyor belt to move the conveyor belt with out slippage between the belt and the pulley, various means have been devised to increase the friction between the drive pulley and the conveyor belt. Among those are the application of “lagging” on the surface of the drive pulley to increase the friction between the drive pulley and the conveyor belt.

While pulley lagging may take different forms, one form is to provide rubber pulley covers for the drive pulley because of the high coefficient of friction of rubber and rubber like materials. The friction level can be improved by patterning the rubber covers, much like a tread pattern does for a vehicle tire.

Rubber, however, tends to wear away, particularly in an environment where particulate matter, especially hard and gritty particulate matter is present. When such matter is pressed against the rubber pulley lagging cover it tends to act similarly to an abrasive to increase the rate of wear. To resist such wear, ceramic elements have been added to pulley lagging, e.g., as plural tiles embedded in a pattern in a rubber pulley lagging base. Typically, the rubber pulley lagging has one or more parallel longitudinal grooves between the ceramic elements to provide flexibility for conforming the pulley lagging to the curvature of the drive pulley and have beveled longer edges so that adjacent lagging pieces can abut each other without leaving a gap therebetween.

FIG. 1 is a perspective view and FIGS. 1A, 1B and 1C are a plan view, a side view and an end view, respectively, of an example prior art ceramic tile 900 for pulley lagging. Such ceramic tiles could be rectangular in shape, but the example illustrated has a parallelogram shape for use in the ARROWHEAD™ pulley lagging available from ASGCO Manufacturing, Inc. located in Allentown, Pa. Prior art ceramic tile 900 has a ceramic body 910 in the shape of a parallelogram having broad front and back surfaces 914 of the same size, both in the shape of the parallelogram with generally rectangular sides 912 therebetween that are orthogonal to both front and back surfaces 914. Adjacent sides 912 intersect with curved sections for smooth transitions. The ceramic tile bodies 910 when embedded into a rubber protective pulley base tend to improve the wear characteristics of the conventional pulley lagging.

However, the level of friction with the belt and/or the durability against wear may be improved when each of the front and back surfaces 914 of ceramic tile 900 has a pattern of raised “nubs” 920 on the exposed surface thereof. Because prior art tiles 900 are used in the ASGCO arrowhead pattern, nubs 920 are provided on both the front and back surfaces 914 so that alternating ones of ceramic tiles 900 can be flipped over so that the parallelogram shapes when placed side by side resemble an arrowhead shape. This shape provides an advantage in that a single shape of ceramic tile 900 may be employed to form different patterns of ceramic tiles such as the arrowhead pattern. Each nub 920 is in the form of a short right circular cylinder 920 extending from a surface 914 of tile body 910. As an approximation, the thickness of body 910 is about ½ the total thickness of ceramic tile 900 and the height of nubs 920 is about ¼ the total thickness of ceramic tile 900. The example pattern of nubs 920 has three parallel rows of five evenly-spaced nubs each, with each row being inset from the edges of tile body 910 and being offset from the adjacent row by about ⅓ of the spacing between adjacent nubs 920 in each row.

While the described conventional ceramic tiles 900 perform very satisfactorily in a rubber bedded pulley lagging, high wear and high load induced stresses can cause separation between the tiles and the rubber bedding to occur.

Applicant believes there may be a need for a ceramic tile pulley lagging that provides at least the same levels of wear and friction as the conventional ceramic tile pulley lagging, but that has greater resistance to separation from the rubber bedding of the lagging.

Accordingly, pulley lagging may comprise: a resilient base; a plurality of ceramic tiles each having a tile body having first and second broad surfaces defining a thickness that is less than the thickness of the resilient base, each tile body having a plurality of side surfaces extending between the first and second broad surfaces thereof, wherein the first broad surface thereof is larger than the second broad surface thereof, and wherein the plurality of sides taper inwardly towards the second broad surface thereof; each ceramic tile having a plurality of intersecting grooves on the first broad surface thereof and having a plurality of raised nubs on the second broad surface thereof; the plurality of ceramic tiles each having substantially all of the tile body thereof and the first broad surface thereof embedded in the resilient base, whereby the plurality of raised nubs extend from the resilient base.

In another aspect, a ceramic tile for pulley lagging may comprise: a tile body having first and second broad surfaces defining a thickness, each tile body having a plurality of side surfaces extending between the first and second broad surfaces thereof, wherein the first broad surface thereof is larger than the second broad surface thereof, and wherein the plurality of sides taper inwardly towards the second broad surface thereof; each ceramic tile having a plurality of intersecting grooves on the first broad surface thereof and having a plurality of raised nubs on the second broad surface thereof.

### BRIEF DESCRIPTION OF THE DRAWING

The detailed description of the preferred embodiment(s) will be more easily and better understood when read in conjunction with the FIGURES of the Drawing which include:

FIG. 1 is a perspective view and FIGS. 1A, 1B and 1C are a plan view, a side view and an end view, respectively, of a prior art ceramic tile for pulley lagging;

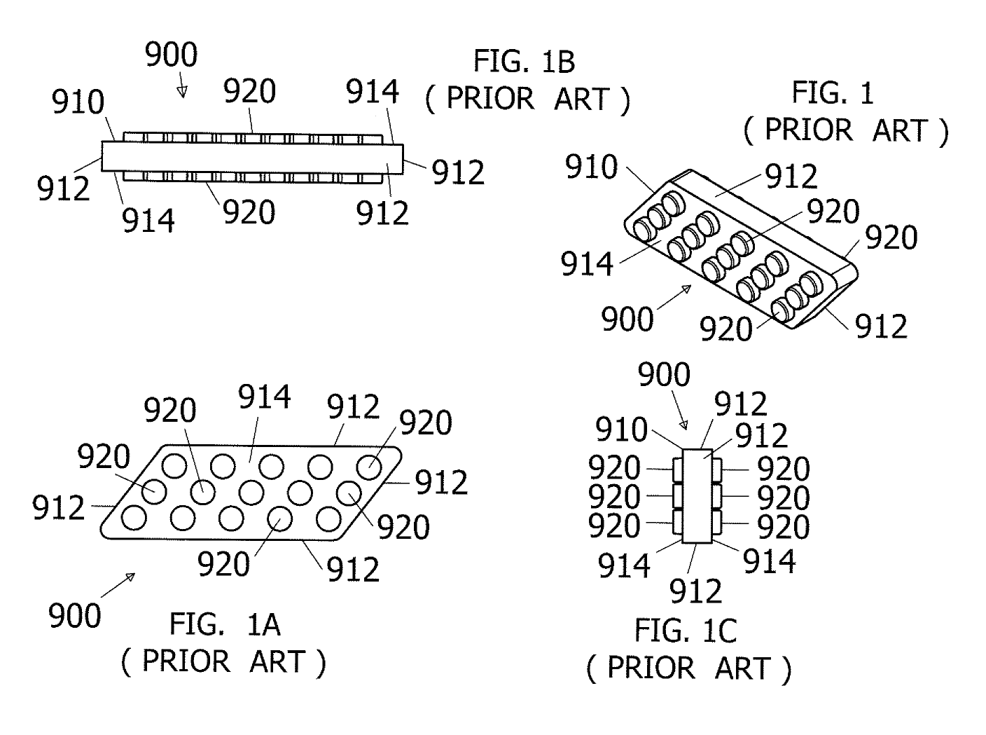

FIG. 2 is a plan view of a section of an example embodiment of pulley lagging including a plurality of ceramic tiles embedded therein;

FIG. 3 is a perspective view and FIGS. 3A, 3B, 3C and 3D are a front plan view, a side view, an end view, and a rear plan view, respectively, of an example embodiment of a first new ceramic tile for pulley lagging; and

FIG. 4 is a perspective view and FIGS. 4A, 4B, 4C and 4D are a front plan view, a side view, an end view, and a rear plan view, respectively, of an example embodiment of a second new ceramic tile for pulley lagging that is a mirror image of the first new ceramic tile.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. According to common practice, the various features of the drawing are not to scale, and the dimensions of the various features may be arbitrarily expanded or reduced for clarity, and any value stated is given by way of example only.

### DESCRIPTION OF THE PREFERRED EMBODIMENT(S)

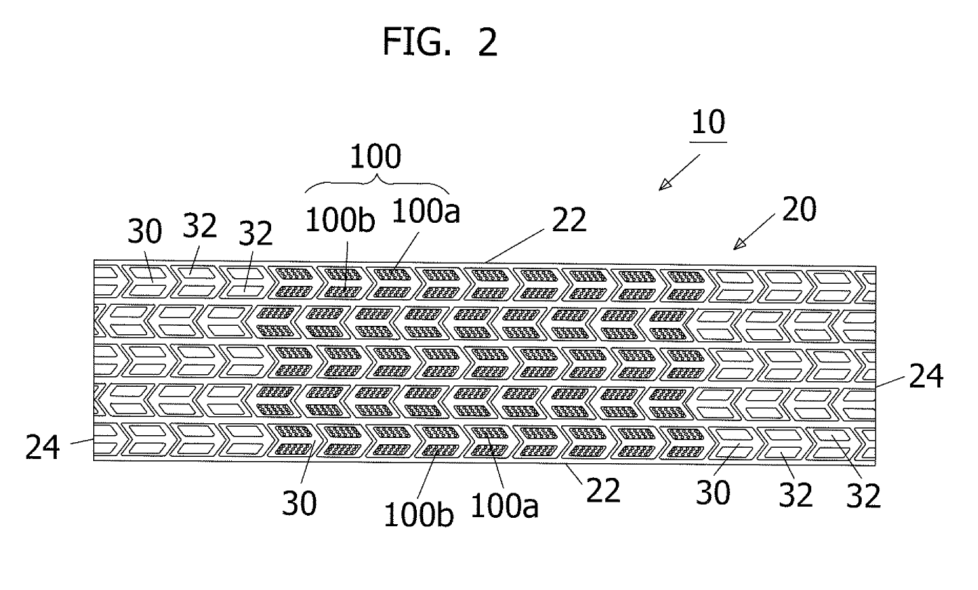

FIG. 2 is a plan view of a section of an example embodiment of pulley lagging including a plurality of ceramic tiles 100 embedded therein. Pulley lagging 10 comprises a resilient bed or base 20, e.g., of a rubber or rubber like material, in which are embedded a plurality of ceramic tiles 100a, 100b, at least in a central portion thereof. The rubber or rubber like bed or base 20 can be attached to a cylindrical pulley surface, e.g., by a suitable adhesive, with its long edges 22 transverse to the pulley (e.g., parallel to its rotational axis) and its short edges 24 generally aligned with the curved edges of the pulley. Resilient base 20 may have, and preferably has, one or more longitudinal grooves therein to provide flexibility in the direction needed to facilitate rubber base 20 conforming to the curvature of the pulley. Resilient rubber base 20 may also have, and preferably has, its long edges 22 beveled so that base 20 is slightly narrower at the bottom surface that abuts the pulley than at its top surface, so as to more closely abut adjacent rubber bases 20 without leaving a gap when attached to a pulley. A bevel angle of about 15° is typical for providing acceptable abutted positioning.

Resilient rubber base 20 of pulley lagging 10 may have a pattern of raised features thereon, e.g., arrowhead like raised features 30 each having therein a mirror image pair of raised parallelogram features 32. Arrowhead like raised features 30 are generally provided across the full length and width of rubber base 20. Raised features 32 are generally provided at the ends of rubber base 20, e.g., in each of the about one quarter (¼) or less of the length thereof adjacent to each of shorter edges 24. Within the arrowhead like raised features 30 in the central about one half (½) or more of rubber base 20, each arrowhead feature 30 has a pair of mirror image ceramic tiles 100a, 100b embedded therein.

Generally, the length of the array of ceramic tiles 100 embedded in a central portion or region of rubber base 20 of pulley lagging 10 is typically about the same as the width of the conveyor belt it is intended for use with, e.g., is generally in a range between about 90 percent and about 110-115 percent of the width of the intended belt and is preferably at lest the width of the intended belt. Since the width of the drive pulley is typically about 3-6 inches (about 7.6-15.2 cm) greater than the width of the belt, the length of rubber base 20 of pulley lagging 10 is typically such that a length of at least 6 inches (15.2 cm), and typically about 7-9 inches (about 17.5-23 cm), of lagging base 20 is provided in end regions without ceramic tiles at both ends thereof with the array of ceramic tiles 100 therebetween. The foregoing may be the case where the pulley lagging 10 is provided s individual pieces or is provided as a long strip, e.g., a rolled up strip.

The length of lagging 10 when installed on a pulley is typically the same as or slightly shorter than the width of the pulley onto which it is intended to be mountable, lagging 10 has a length which may be longer than the width of the pulley it is intended to be used with, lagging 10 is typically cut to length as part of its installation on the pulley. Since the lagging 10 is generally intended to have the rubber base 20 cut to length during installation, the rubber base 20 may be and typically is longer than necessary.

The pairs of mirror image ceramic tiles 100a, 100a, 100b preferably are embedded in resilient base 20 with ones of their longer sides adjacent so as to appear in an arrowhead like shape similar to, but smaller than, that of raised features 30. Adjacent rows of arrowhead like features 30 are preferably arranged to “point” in opposite directions, alternating between left pointing and right pointing arrowhead like patterns 30. In the example illustrated, which is an example of pulley lagging 10 having an about 40 inch (about 100 cm) length that is usable with a pulley having an about 40 inch (about 100 cm) width, such as could be used with an about 24 inch (about 61 cm) wide belt, there are five rows of arrowhead features that extend across the entire pulley width. In the central portion thereof, each of the five rows of arrowhead features includes two rows of ceramic tiles therein, thereby totaling ten rows of ceramic tiles 100a, 100b. Each of the ten rows has about nine ceramic tiles 100a, 100b along its length, wherein all of the 90 tiles 100a, 100b are in the central portion of pulley lagging 10.

Preferably, each ceramic tile 100a, 100b is embedded in rubber base 20 with its top broad surface substantially in plane with the planar surface of rubber base 20 and has a pattern of exposed projections, e.g., exposed nubs, that are of comparable height to that of the raised arrowhead shaped features 30, e.g., for improving friction between the pulley and the conveyor belt. Ceramic tiles 100 may be embedded in resilient base 20 to a lesser or greater degree, thereby leaving a greater or lesser portion of tiles 100 exposed.

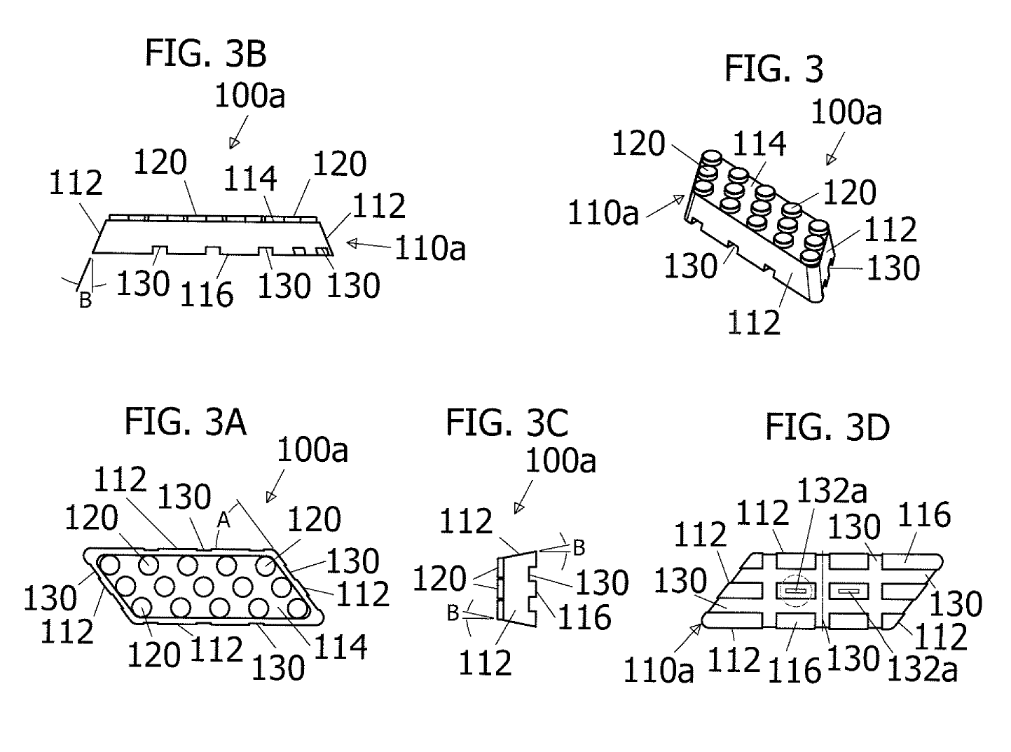

FIG. 3 is a perspective view and FIGS. 3A, 3B, 3C and 3D are a front (or top) plan view, a side view, an end view, and a rear (or bottom) plan view, respectively, of an example embodiment of a first new ceramic tile 100a for pulley lagging. Ceramic tile 100a has a ceramic body 110a in the shape of a parallelogram and has a broad front surface 114 and a broad back surface 116, wherein rear surface 116 is larger than is front surface 114, both in the shape of the parallelogram with generally rectangular sides 112 therebetween that are angled so as not to be orthogonal to either front surface 114 or back surface 116. Adjacent sides 112 intersect at an acute angle A, e.g., typically at an angle between about 45° and about 60°, and preferably at an angle of about 52°, with curved sections at each corner of the tile body 110a having a radius for providing smooth transitions. The ceramic tile bodies 110a when embedded into a rubber protective pulley lagging base 20 are preferably positioned such that their broad top surfaces 114 are substantially planar with the broad top surface of rubber base 20.

Ceramic tile 100a has a tile body 110a that is larger at its rear surface 116 than it is at its front surface 114, e.g., so as to have a tapered shape when viewed from any side 112, wherein tile body 1100a appears generally trapezoidal when viewed from the side. Preferably, each of sides 112 is angled with respect to front and rear surfaces 114, 116 so as to be at an angle B, e.g., typically at an angle B between about 10° and about 15° and preferably at an angle B of about 11-12°, with respect to a line that is perpendicular to either of surfaces 114, 116. With a wider rear or base 116 than top 114, ceramic tile 100a has a shape that tends to be at least partially enveloped or surrounded by the rubber of base 20 in which it is embedded, thereby to be better retained thereby. As a result, ceramic tiles 100a are more securely retained in rubber base 20 than are prior art tiles, so that new ceramic tile pulley lagging 10 tends to be more durable than is conventional pulley lagging employing prior art tiles.

However, the level of friction with the belt and/or the durability against wear may be improved when the front surface 114 of ceramic tile 100a has a pattern of raised “nubs” 120 on the exposed surface 114 thereof. Because example ceramic tiles 100a are intended to be used in the ASGCO ARROWHEAD™ pulley lagging pattern and are not symmetrical, nubs 120 are provided only on front or top surface 114 thereof, and a “mirror image” ceramic tile, e.g., a ceramic tile 100b, may be provided to be placed along side of ceramic tile 100a to complete the arrowhead pattern of side by side ceramic tiles 100a, 100b.

Each nub 120 of ceramic tile 100a is preferably in the form of a short right circular cylinder 120 extending from a surface 114 of tile body 110a. As an approximation, the thickness of body 1100a is about one half (½) the total thickness of ceramic tile 100a and the height of nubs 120 is about one quarter (¼) the total thickness of ceramic tile 100a. The example pattern of nubs 120 as illustrated has three parallel rows of five evenly-spaced nubs each, with each outer row being essentially adjacent the edge of a side 112 tile body 110a and with each row being offset from the adjacent row by about one third (⅓) of the spacing between adjacent nubs 120 in each row. In a preferred embodiment, the intersection of the edge of each side 112 of ceramic tile 100a intersects surface 114 thereof substantially at the base of the nubs 120 closest thereto at surface 114.

To improve the adhesion of ceramic tile 100a in rubber base 20, a pattern of grooves 130 may be provided on rear surface 116 of ceramic tile 100a. In the illustrated example, grooves 130 are in a cross-hatch pattern wherein plural grooves 130 parallel to the length, e.g., to the longer ones of sides 112, of tile 100a are about orthogonal to the remaining plural grooves 130 which are parallel to the shorter ones of sides 112.

Optionally, one or more distinctive marks or symbols 132a may be provided for identifying tile 100a, as may be desirable, e.g., where ceramic tiles 100 have non-symmetric shapes and are utilized in sets. In the example illustrated, symbol 132a is provided in or by a shallow rectangular recess in bottom surface 116 that appears to be in the shape of the numeral one (“1”) and is provided only on tile 100a. Symbol 132a may be a recess in surface 116 or may be a recess or raised symbol in a groove 130. Typically, symbol 132a is representative of the shape of ceramic tile 100a and a different symbol is preferably provided on other tiles, e.g., on mirror image tile 100b.

Having symbol 132a on rear surface 116 of tile 100a is preferred because it facilitates proper assembly of lagging 10. Lagging 10 is assembled using a metal mold that has the arrowhead pattern 30-32 for rubber base 20 therein and that further has a pattern of recesses into which ceramic tiles 100 are placed, wherein the recesses for ceramic tiles 100a are different from those for ceramic tiles 100b. Tiles 100a are typically placed into the recesses in the metal mold with front surface 114 facing downward in the recesses in the mold that is used to define rubber base 20 of pulley lagging 10, and so symbols 132a on surface 116 or in grooves 130 are visible when tiles 100a are in the mold, whereby it is easier to verify that the proper tiles are in the proper recesses in the metal mold. The layer of uncured rubber 20 is then placed over the mold and the ceramic tiles therein and the uncured neoprene layer is placed over the uncured rubber layer. Then the layers of rubber and neoprene are compressed against the mold at an elevated temperature so that at least a substantial portion of bases 110a, 100b of ceramic tiles 100, and preferably the entire bases 110a, 110 b thereof, are pressed into rubber layer 20 and the rubber layer and neoprene layers are heat bonded together and cured. When removed from the mold, ceramic tiles 100 are embedded in the cured rubber base 20 which has the arrowhead pattern formed therein.

The ceramic tile bodies 110a when embedded into a rubber protective pulley base are preferably positioned such that their broad top surface 114 is substantially planar with the broad top surface of rubber base 20 so that nubs 120 are exposed, e.g., to tend to improve the wear characteristics over that of conventional pulley lagging not having such ceramic tiles.

While ceramic tiles 100a of the example illustrated have a parallelogram like shape as is preferable for use in the ARROWHEAD™ pulley lagging available from ASGCO Manufacturing, Inc. located in Allentown, Pa., ceramic tiles 100a could be of any other desired shape, e.g., of a triangular, rectangular, square, hexagonal or other shape, including a geometric or non-geometric shape.

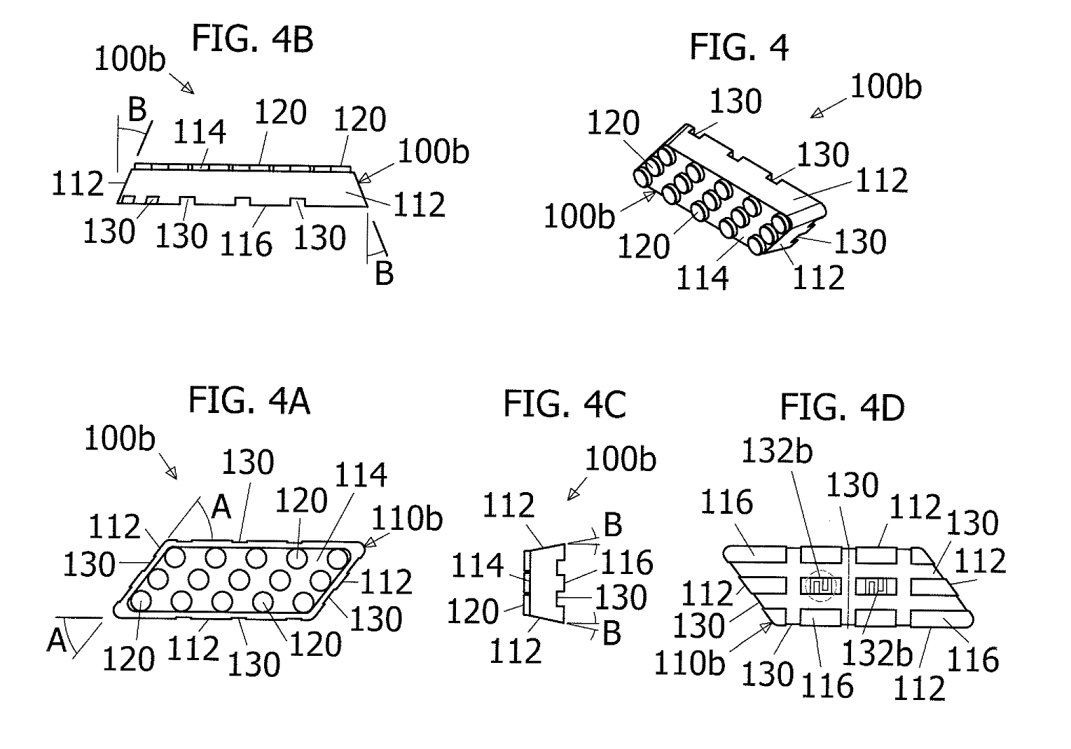

FIG. 4 is a perspective view and FIGS. 4A, 4B, 4C and 4D are a front (or top) plan view, a side view, an end view, and a rear (or bottom) plan view, respectively, of an example embodiment of a second new ceramic tile 100b for pulley lagging that is a mirror image of the first new ceramic tile 100a. Ceramic tile 100b has a ceramic body 110b in the shape of a parallelogram having a broad front surface 114 and a broad back surface 116, wherein rear surface 116 is larger than is front surface 114, both in the shape of the parallelogram with generally rectangular sides 112 therebetween that are angled so as not to be orthogonal to either front surface 114 or back surface 116. Adjacent sides 112 intersect at an acute angle A, e.g., typically at an angle between about 45 and about 60°, and preferably at an angle of about 52°, with curved sections at each corner of the tile body 110b having a radius for providing smooth transitions. The ceramic tile bodies 110b when embedded into a rubber protective pulley lagging base 20 are preferably positioned such that their broad top surfaces 114 are substantially planar with the broad top surface of rubber base 20. The parallelogram of ceramic tile body 110b is preferably a mirror image of the parallelogram of ceramic tile body 110a.

Ceramic tile 100b has a tile body 110b that is larger at its rear surface 116 than it is at its front surface 114, e.g., so as to have a tapered shape when viewed from any side 112, wherein tile body 110b appears generally trapezoidal when viewed from the side. Preferably, each of sides 112 is angled with respect to front and rear surfaces 114, 116 so as to be at an angle B, e.g., typically at an angle B between about 10° and about 15° and preferably at an angle B of about 11-12°, with respect to a line that is perpendicular to either of surfaces 114, 116. With a wider rear or base 116 than top 114, ceramic tile 100b has a shape that tends to be at least partially enveloped or surrounded by the rubber of base 20 in which it is embedded, thereby to be better retained thereby. As a result, ceramic tiles 100b are more securely retained in rubber base 20 than are prior art tiles, so that new ceramic tile pulley lagging 10 tends to be more durable than is conventional pulley lagging employing prior art tiles.

However, the level of friction with the belt and/or the durability against wear may be improved when the front surface 114 of ceramic tile 100b has a pattern of raised “nubs” 120 on the exposed surface 114 thereof. Because example ceramic tiles 100b are intended to be used in the ASGCO ARROWHEAD™ pulley lagging pattern and are not symmetrical, nubs 120 are provided only on front or top surface 114 thereof, and a “mirror image” ceramic tile, e.g., a ceramic tile 100a, may be provided to be placed along side of ceramic tile 100b to complete the arrowhead pattern of side by side ceramic tiles 100a, 100b.

Each nub 120 of ceramic tile 100b is preferably in the form of a short right circular cylinder 120 extending from a surface 114 of tile body 110b. As an approximation, the thickness of body 110b is about one half (½) the total thickness of ceramic tile 100b and the height of nubs 120 is about one quarter (¼) the total thickness of ceramic tile 100b. The example pattern of nubs 120 as illustrated has three parallel rows of five evenly-spaced nubs each, with each outer row being essentially adjacent the edge of a side 112 tile body 110b and with each row being offset from the adjacent row by about one third (⅓) of the spacing between adjacent nubs 120 in each row. In a preferred embodiment, the intersection of the edge of each side 112 of ceramic tile 100b intersects surface 114 thereof substantially at the base of the nubs 120 closest thereto at surface 114.

To improve the adhesion of ceramic tile 100b in rubber base 20, a pattern of grooves 130 may be provided on rear surface 116 of ceramic tile 100b. In the illustrated example, grooves 130 are in a cross-hatch pattern wherein plural grooves 130 parallel to the length, e.g., to the longer ones of sides 112, of tile 100b are about orthogonal to the remaining plural grooves 130 which are parallel to the shorter ones of sides 112. In the example tile 100b illustrated, there are two parallel grooves running in the longer dimension and three parallel grooves 130 running in the shorter dimension.

Optionally, one or more distinctive marks or symbols 132b may be provided for identifying tile 100b, as may be desirable, e.g., where ceramic tiles 100 have non-symmetric shapes and are utilized in sets. In the example illustrated, symbol 132b is provided in or by a shallow rectangular recess in bottom surface 116 that appears to be in the shape of the numeral two (“2”) and is provided only on tile 100b. Symbol 132b may be a recess in surface 116 or may be a recess or raised symbol in a groove 130. Typically, symbol 132b is representative of the shape of ceramic tile 100b and a different symbol is preferably provided on other tiles, e.g., on mirror image tile 100a.

Having symbol 132b on rear surface 116 of tile 100b is preferred because it facilitates proper assembly of lagging 10. Lagging 10 is assembled using a metal mold that has the arrowhead pattern 30-32 for rubber base 20 therein and that further has a pattern of recesses into which ceramic tiles 100 are placed, wherein the recesses for ceramic tiles 100b are different from those for ceramic tiles 100a. Tiles 100b are typically placed into the recesses in the metal mold with front surface 114 facing downward in the recesses in the mold that is used to define rubber base 20 of pulley lagging 10, and so symbols 132b on surface 116 or in grooves 130 are visible when tiles 100b are in the mold, whereby it is easier to verify that the proper tiles are in the proper recesses in the metal mold. The layer of uncured rubber 20 is then placed over the mold and the ceramic tiles therein and an uncured neoprene layer is placed over the uncured rubber layer. Then the layers of rubber and neoprene are compressed against the mold at an elevated temperature so that at least a substantial portion of bases 110a, 100b of ceramic tiles 100, and preferably the entire bases 110a, 110b thereof, are pressed into rubber layer 20 and the rubber layer and neoprene layers are heat bonded together and cured. When removed from the mold, ceramic tiles 100 are embedded in the cured rubber base 20 which has the arrowhead pattern formed therein.

The ceramic tile bodies 110b when embedded into a rubber protective pulley base are preferably positioned such that their broad top surface 114 is substantially planar with the broad top surface of rubber base 20 so that nubs 120 are exposed, e.g., to tend to improve the wear characteristics over that of conventional pulley lagging not having such ceramic tiles.

While ceramic tiles 100b of the example illustrated have a parallelogram like shape as is preferable for use in the ARROWHEAD™ pulley lagging available from ASGCO Manufacturing, Inc. located in Allentown, Pa., ceramic tiles 100b could be of any other desired shape, e.g., of a triangular, rectangular, square, hexagonal or other shape, including a geometric or non-geometric shape.

In one typical embodiment, each piece of pulley lagging 10 for an about 24 inch (about 61 cm) wide belt which is supported by an about 39.5 inch (about 100 cm) wide pulley may have a length of about 39.5 inches (about 100 cm) and a width of about 10 inches (about 25.4 cm) and be about 0.77 inch (about 19.6 mm) thick. A central portion of about 22.6 inches (about 57.4 cm) contains about 90 ceramic tiles 100a, 100b. Each ceramic tile 100a, 100b is about 0.63 inch (about 16 mm) wide at bottom surface 116, about 1.8 inches (about 4.6 cm) long at top surface 114 and about 2.0 inches (about 5.1 cm) long at bottom surface 116, and about 0.32 inch (about 8 mm) thick. Therein, acute angle A of the parallelogram shape is typically about 52° and the taper angle B of sides 112 is typically about 11-12°. Nubs 120 thereof project above the broad top surface 114 by about 0.05 inch (about 1.3 mm) and are about 0.16 inch (about 4.1 mm) in diameter. Grooves 130 are about 0.12 inch (about 3 mm) wide and about 0.06 inch (about 1.5 mm) deep, and are in an orthogonal cross hatch pattern with two longitudinal grooves and three transverse grooves.

In one variant of the foregoing example embodiment intended for an about 72 inch (about 180 cm) wide belt which is supported by an about 89 inch (about 226 cm) wide pulley, pulley lagging 10 may have a length of about 89 inches (about 226 cm) and a width of about 10 inches (about 25.4 cm) and be about 0.77 inch (about 19.6 mm) thick. A central portion of about 71.4 inches (about 181 cm) contains about 290 ceramic tiles 100a, 100b as described that are disposed in rubber base 20 as described.

In one example embodiment, rubber base 20 preferably has a thickness of about 0.63 inch (about 16 mm) and preferably includes a relatively thicker base layer of about 0.51 inch (about 13 mm) thick rubber backed by a relatively thinner backing layer of about 0.12 inch (about 3 mm) thick neoprene rubber vulcanized thereto for better adhesive bonding strength between the pulley lagging 10 and the pulley. Other suitable resilient materials for base 20 include, e.g., EPDM rubber, urethane, and silicone. Ceramic tiles 100a, 100b preferably are of an aluminum oxide ceramic material or other suitable ceramic material, and are embedded in the rubber base layer 20 with their surfaces 114 substantially coplanar with the surface of the rubber base layer which has about 0.38 inch (about 10 mm) wide and about 0.25 (about 6 mm) deep longitudinal grooves therein. Other suitable ceramic materials for tiles 100, 100a, 100b include, e.g., alumina ceramic, silica ceramic, and beryllium oxide ceramic.

Ceramic tile pulley lagging 10 may comprise: a resilient base 20 having first and second broad surfaces each having a length greater than its width, and having a thickness; a plurality of ceramic tiles each having a tile body 110 having first and second broad surfaces 116, 114 defining a thickness that is less than the thickness of the resilient base 20, each tile body 110 having a plurality of side surfaces 112 extending between the first and second broad surfaces 116, 114 thereof, wherein the first broad surface 116 thereof is larger than the second broad surface 114 thereof, and wherein the plurality of sides 112 taper inwardly towards the second broad surface 114 thereof; each ceramic tile having a plurality of intersecting grooves 130 on the first broad surface 116 thereof and having a plurality of raised nubs 120 on the second broad surface 114 thereof; the plurality of ceramic tiles 100 each having substantially all of the tile body 110 thereof and the first broad surface 116 thereof embedded in the resilient base 20, whereby the plurality of raised nubs extend from the resilient base 20. The plurality of ceramic tiles 100 may be disposed in one or more rows along at least part of the length of the resilient base 20 in the first broad surface thereof, the resilient base 20 having at least one longitudinal groove in the first broad surface thereof between adjacent rows of the plurality of ceramic tiles. The first and second broad surfaces 116, 114 of the tile body 110 of the ceramic tile may have a parallelogram shape; or one of more of the plurality of side surfaces of the tile body 110 of the ceramic tile may have a trapezoidal shape; or the first and second broad surfaces 116, 114 of the tile body 110 of the ceramic tile may have a parallelogram shape and one of more of the plurality of side surfaces of the tile body 110 of the ceramic tile may have a trapezoidal shape. Adjacent sides 112 of the parallelogram may be at an acute angle of about 50-55 degrees. The plurality of sides 112 may taper inwardly towards the second broad surface 114 of the tile body 110 at an angle of about 10-15 degrees. An edge of the plurality of sides 112 of the tile body 110 may intersect the second broad surface 114 thereof substantially at the raised nubs 120 closest thereto. The plurality of intersecting grooves 130 on the first broad surface 116 of the tile body 110 may have rectangular groves 130; or may have orthogonal intersecting grooves 130; or may have orthogonal intersecting rectangular grooves 130. The plurality of raised nubs 120 may include: nubs 120 arranged in one or more rows; or nubs 120 that are substantially cylindrical; or nubs 120 that are substantially cylindrical arranged in one or more rows. The plurality of ceramic tiles 100 may include sets of ceramic tiles 100a, 100b having non-symmetrical shapes, and the first broad surface 116 of each tile body 110a, 100b thereof may include a symbol 132a, 132b representative of the non-symmetrical shape. The tile bodies 110 of the plurality of ceramic tiles 100 may include ceramic, aluminum oxide, or both. The resilient base may have beveled longer sides 22 along the length for reducing a gap between adjacent ones of ceramic tile pulley lagging 10 when the adjacent ones of ceramic tile pulley lagging 10 are mounted to a pulley. The resilient base 20 may be of a rubber and may have a layer of neoprene rubber on the second broad surface thereof.

A ceramic tile 100 for pulley lagging 10 may comprise: a tile body 110 having first and second broad surfaces 116, 114 defining a thickness, each tile body 110 having a plurality of side surfaces extending between the first and second broad surfaces 116, 114 thereof, wherein the first broad surface 116 thereof is larger than the second broad surface 114 thereof, and wherein the plurality of sides 112 taper inwardly towards the second broad surface 114 thereof; each ceramic tile 100 may have a plurality of intersecting grooves 130 on the first broad surface 116 thereof and having a plurality of raised nubs 120 on the second broad surface 114 thereof. A plurality or ceramic tiles 100 may be disposed in one or more rows along at least part of the length of a resilient base 20 in a first broad surface thereof, the resilient base 20 having at least one longitudinal groove in the first broad surface thereof between adjacent rows of ceramic tiles 100. The first and second broad surfaces 116, 114 of the tile body 110 of the ceramic tile 100 may have a parallelogram shape; or one of more of the plurality of side surfaces 112 of the tile body 110 of the ceramic tile 100 may have a trapezoidal shape; or the first and second broad surfaces 116, 114 of the tile body 110 of the ceramic tile 100 may have a parallelogram shape and one of more of the plurality of side surfaces 112 of the tile body 110 of the ceramic tile 100 may have a trapezoidal shape. Adjacent sides 112 of the parallelogram may be at an acute angle of about 50-55 degrees. The plurality of sides 112 may taper inwardly towards the second broad surface 114 of the tile body 110 at an angle of about 10-15 degrees. An edge of the plurality of sides 112 of the tile body 110 may intersect the second broad surface 114 thereof substantially at the raised nubs closest thereto. The plurality of intersecting grooves 130 on the first broad surface 116 of the tile body 110 may have rectangular groves 130; or may have orthogonal intersecting grooves 130; or may have orthogonal intersecting rectangular grooves 130. The plurality of raised nubs 120 may include nubs 120 arranged in one or more rows; or nubs 120 that are substantially cylindrical; or nubs 120 that are substantially cylindrical arranged in one or more rows. The ceramic tile 100 for pulley lagging 10 may include at least one set of the ceramic tiles 100, the ceramic tiles 100a, 100b of the at least one set 100 having non-symmetrical shapes, wherein the first broad surface 116 of each tile body 110a, 110b thereof includes a symbol 132a, 132b representative of the non-symmetrical shape. The tile body 110 of the ceramic tile 100 may include ceramic, aluminum oxide, or both.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Although terms such as “up,” “down,” “left,” “right,” “front,” “rear,” “side,” “top,” “bottom,” “forward,” “backward,” “under” and/or “over,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

Further, what is stated as being “optimum” or “deemed optimum” may or may not be a true optimum condition, but is the condition deemed to be desirable or acceptably “optimum” by virtue of its being selected in accordance with the decision rules and/or criteria defined by the designer and/or applicable controlling function.

While the present invention has been described in terms of the foregoing example embodiments, variations within the scope and spirit of the present invention as defined by the claims following will be apparent to those skilled in the art. For example, while ceramic tiles 100a, 100b having a parallelogram like shape are described herein and are preferred, ceramic tiles 100 of other shapes may be employed in accordance with the present arrangement. Ceramic tiles 100 that are rectangular, or square, or that have a greater or lesser number of sides, may be provided with the tapered sides and grooved back surfaces as described herein. Ceramic tiles 100 that are not prismatic, e.g., that do not have a plurality of distinct sides, such a circular or oval or elliptical tiles, are considered to have a very large number of sides and so are still considered to have plural sides of trapezoidal shape.

While the mirror-image parallelogram shapes of ceramic tiles 100a, 100b are preferred where pulley lagging 10 has an arrowhead-like pattern as illustrated, ceramic tiles 100 may have symmetrical shapes and/or non-symmetrical shapes as may be desired for any particular pattern. Where the pattern only requires ceramic tiles 100 of the same symmetrical shape, it is not necessary to provide mirror image tiles as is the case for ceramic tiles 100a, 100b.

Further, the example shape, dimensions, parallelogram angles, and/or taper angles of ceramic tiles 100a, 100b may be larger, smaller and/or different than those stated as being preferred. In addition, the example size, shape and/or patterns of nubs 120 and of grooves 130 also may be larger, smaller, different in number, different in layout, and/or otherwise different than those stated as being preferred.

While optional symbols 132a, 132b are illustrated as being representative of numerals, in addition or in the alternative, symbols representative of characters, alphabetic characters, shapes, and other symbols and marks, may be employed. While the illustrated example symbols 132a, 132b are provided by shallow recessed features, suitable symbols may be provided by raised features, by recessed features, or by both raised and recessed features.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. Ceramic tile pulley lagging comprising:
a resilient base having first and second broad surfaces each having a length greater than its width, and having a thickness;
a plurality of ceramic tiles each having a tile body having first and second broad surfaces defining a thickness that is less than the thickness of said resilient base, each tile body having a plurality of side surfaces extending between the first and second broad surfaces thereof, wherein the first broad surface thereof is larger than the second broad surface thereof, and wherein the plurality of sides taper inwardly towards the second broad surface thereof;
each ceramic tile having a plurality of intersecting grooves on the first broad surface thereof and having a plurality of raised nubs on the second broad surface thereof;
said plurality of ceramic tiles each having substantially all of the tile body thereof and the first broad surface thereof embedded in said resilient base,
whereby the plurality of raised nubs extend from said resilient base.

2. The ceramic tile pulley lagging of claim 1 wherein said plurality of ceramic tiles are disposed in one or more rows along at least part of the length of said resilient base in the first broad surface thereof, said resilient base having at least one longitudinal groove in the first broad surface thereof between adjacent rows of said plurality of ceramic tiles.

3. The ceramic tile pulley lagging of claim 1 wherein:
the first and second broad surfaces of the tile body of said ceramic tile have a parallelogram shape; or
one of more of the plurality of side surfaces of the tile body of said ceramic tile has a trapezoidal shape; or
the first and second broad surfaces of the tile body of said ceramic tile have a parallelogram shape and one of more of the plurality of side surfaces of the tile body of said ceramic tile has a trapezoidal shape.

4. The ceramic tile pulley lagging of claim 3 wherein adjacent sides of the parallelogram are at an acute angle of about 50-55 degrees.

5. The ceramic tile pulley lagging of claim 1 wherein the plurality of sides taper inwardly towards the second broad surface of said tile body at an angle of about 10-15 degrees.

6. The ceramic tile pulley lagging of claim 1 wherein an edge of the plurality of sides of said tile body intersects the second broad surface thereof substantially at the raised nubs closest thereto.

7. The ceramic tile pulley lagging of claim 1 wherein the plurality of intersecting grooves on the first broad surface of the tile body:
have rectangular groves; or
have orthogonal intersecting grooves; or
have orthogonal intersecting rectangular grooves.

8. The ceramic tile pulley lagging of claim 1 wherein the plurality of raised nubs includes:
nubs arranged in one or more rows; or
nubs that are substantially cylindrical; or
nubs that are substantially cylindrical arranged in one or more rows.

9. The ceramic tile pulley lagging of claim 1 wherein said plurality of ceramic tiles includes sets of ceramic tiles having non-symmetrical shapes, wherein the first broad surface of each tile body thereof includes a symbol representative of the non-symmetrical shape.

10. The ceramic tile pulley lagging of claim 1 wherein the tile bodies of said plurality of ceramic tiles includes ceramic, aluminum oxide, or both.

11. The ceramic tile pulley lagging of claim 1 wherein said resilient base has beveled longer sides along the length for reducing a gap between adjacent ones of ceramic tile pulley lagging when the adjacent ones of ceramic tile pulley lagging are mounted to a pulley.

12. The ceramic tile pulley lagging of claim 1 wherein said resilient base is of a rubber and has a layer of neoprene rubber on the second broad surface thereof.

13. A ceramic tile for pulley lagging comprising:
a tile body having first and second broad surfaces defining a thickness, each tile body having a plurality of side surfaces extending between the first and second broad surfaces thereof, wherein the first broad surface thereof is larger than the second broad surface thereof, and wherein the plurality of sides taper inwardly towards the second broad surface thereof;
each ceramic tile having a plurality of intersecting grooves on the first broad surface thereof and having a plurality of raised nubs on the second broad surface thereof.

14. The ceramic tile for pulley lagging of claim 13 wherein a plurality thereof are disposed in one or more rows along at least part of the length of a resilient base in a first broad surface thereof, said resilient base having at least one longitudinal groove in the first broad surface thereof between adjacent rows of ceramic tiles.

15. The ceramic tile for pulley lagging of claim 13 wherein:
the first and second broad surfaces of the tile body of said ceramic tile have a parallelogram shape; or
one of more of the plurality of side surfaces of the tile body of said ceramic tile has a trapezoidal shape; or
the first and second broad surfaces of the tile body of said ceramic tile have a parallelogram shape and one of more of the plurality of side surfaces of the tile body of said ceramic tile has a trapezoidal shape.

16. The ceramic tile for pulley lagging of claim 15 wherein adjacent sides of the parallelogram are at an acute angle of about 50-55 degrees.

17. The ceramic tile for pulley lagging of claim 13 wherein the plurality of sides taper inwardly towards the second broad surface of said tile body at an angle of about 10-15 degrees.

18. The ceramic tile for pulley lagging of claim 13 wherein an edge of the plurality of sides of said tile body intersects the second broad surface thereof substantially at the raised nubs closest thereto.

19. The ceramic tile for pulley lagging of claim 13 wherein the plurality of intersecting grooves on the first broad surface of the tile body:
have rectangular groves; or
have orthogonal intersecting grooves; or
have orthogonal intersecting rectangular grooves.

20. The ceramic tile for pulley lagging of claim 13 wherein the plurality of raised nubs includes:
nubs arranged in one or more rows; or
nubs that are substantially cylindrical; or
nubs that are substantially cylindrical arranged in one or more rows.

21. The ceramic tile for pulley lagging of claim 13 including at least one set of said ceramic tiles, the ceramic tiles of the at least one set having non-symmetrical shapes, wherein the first broad surface of each tile body thereof includes a symbol representative of the non-symmetrical shape.

22. The ceramic tile for pulley lagging of claim 13 wherein the tile body thereof includes ceramic, aluminum oxide, or both.
